(19) United States
(12) Patent Application Publication
(10) Pub. No.: US 2009/0016091 A1
(43) Pub. Date: Jan. 15, 2009

(54) Circuit and system for ultrasonic power regulation

(75) Inventor: Benjaman R. Johnson, Jamestown, NY (US)

Correspondence Address: PHILLIPS LYTLE LLP;INTELLECTUAL PROPERTY GROUP, 3400 HSBC CENTER, BUFFALO, NY, 14203-3509, US

(73) Assignee: Blackstone-Ney Ultrasonics, Inc.

(21) Appl. No.: 11/827,794

(22) Filed: Jul. 13, 2007

(51) Int. Cl. H02M 7/5387; H02M 7/537

(52) U.S. Cl. 363/132; 363/131

(57) ABSTRACT

A circuit for power regulation of ultrasonic generators comprising a half bridge or full bridge circuit and a regulator circuit that controls or regulates the output power of the bridge circuit by, among other things, subtracting bridge voltage from the +VDC power supply. A full range of bridge circuit output powers are efficiently produced by varying the duty cycle of the drive signal to the switching device in the regulator circuit.

### TECHNICAL FIELD

The present invention relates generally to electronic circuits, and more particularly, to the use of half bridge and full bridge circuits for control of output power or power regulation in ultrasonic generators.

### BACKGROUND OF THE INVENTION

For years, half bridge and full bridge electronic circuits have been used as the output power generating topology for various ultrasonic and plasma generators in the frequency range of about 18 khz to 14 Mhz, with ultrasonic generators in the 350 khz to 10 Mhz range often referred to as megasonic generators. Typically, it is desired to set the output power of such generators to some desired value for a particular application, to change this power at will and/or to regulate this power to a constant value when outside factors would otherwise cause it to change. A basic output power control feature is needed to implement these features.

Prior art half bridge and full bridge generator circuits use several different methods to control output power. One commonly used configuration uses a variable voltage power supply to supply the +VDC voltage to a half bridge or full bridge circuit. In such a configuration, as the +VDC voltage is decreased, the output power of the half bridge or full bridge generator decreases. A second commonly used configuration uses variable duty cycle gate drive signals to half bridge or full bridge switching devices. In such a configuration, as the duty cycle of the gate drive signals is decreased, the output power of the half bridge or full bridge generator decreases. These prior art systems have certain disadvantages. For example, prior art variable voltage power supply systems are expensive and inefficient while variable gate drive duty cycle prior art systems lack the ability to linearly control power at low power levels.

### BRIEF SUMMARY OF THE INVENTION

With parenthetical reference to the corresponding parts, portions or surfaces of the disclosed embodiment, merely for purposes of illustration and not by way of limitation, the present invention is generally directed to circuits for control of output power or power regulation. According to one aspect of the invention, a regulator circuit and system allows the output power of a bridge generator to be controlled by inserting a voltage between the emitter or source of a lower switching device in a half bridge, or lower switching devices in a full bridge (this node will be referred to herein as the “bridge bottom” or −VDC) and the minus voltage supply (often ground) (this node will be referred to herein as “ground”).

According to one aspect of the invention, the improved circuit and system has high efficiency because, among other things, there are no resistors to cause IR losses. The operation of the circuit and system comprises, in one aspect, changing the duty cycle of the gate drive to the switching device in a regulator circuit or, in another aspect, changing both the frequency and duty cycle to the gate drive for more efficient switching of the switching device. Higher duty cycles develop a lower voltage at the bottom of the bridge generator; this gives a higher voltage drop across the bridge, which results in high output power and high amplitude. Lower duty cycles develop a higher voltage at the bottom of the bridge generator; this gives a lower voltage drop across the bridge, which results in low output power and low amplitude. In one aspect of the invention, a continuous range of output powers and amplitudes are produced over the continuous range of duty cycles to the base of the circuit's switching device.

Another advantage of the regulator circuit is that its maximum inefficiency is near the middle of the output power range from the bridge circuit. The regulator increases efficiency as the output power of the bridge is raised from about 50% to 100%. This advantage is especially important when compared to state of the art switching supplies that change the voltage to the +VDC supply of the bridge to regulate the output power. These prior art circuits dissipate maximum power at the full power output from the bridge, which is the condition when the bridge is dissipating the maximum power, causing maximum heating and loss at 100% power.

In one aspect of the invention, a regulator circuit comprises an inductor (13) in series with a switching device (12), for example, a power MOSFET, an IGBT (insulated gate bipolar transistor), or a NPN bipolar transistor; with the inductor (13) coupled to the bridge bottom (17) and the source (28) or emitter of the switching device coupled to ground (19). In one aspect, there is a diode (14) from the connection between the inductor and the switching device and the bridge's high voltage +VDC power supply (18). In yet another aspect, some capacitance (15) is connected from the bottom (17) of a bridge circuit (11) to a DC reference (for example 18) or ground (20); this capacitance can be a separate component, or this capacitance may exist as part of the bridge circuit. In another aspect, a resistor (16) may be coupled between the gate terminal (23) of the switching device and the drive terminal (29) which accepts a variable duty cycle waveform. In one aspect of the invention, a half bridge or full bridge circuit (11) is connected between the +VDC terminal (18) and the first terminal (17) of the regulator circuit.

The invention is next described further in connection with preferred embodiments, and it will become apparent that various additions, subtractions, and modifications can be made by those skilled in the art without departing from the scope of the invention.

### BRIEF DESCRIPTION OF DRAWINGS

The foregoing and other objects of this invention, the various features thereof, as well as the invention itself, may be more fully understood from the following description, when read together with the accompanying drawings in which:

FIG. 1 shows a schematic diagram of the main components of the regulator circuit with a bridge circuit shown in block diagram form.

FIG. 2 shows a schematic diagram of a prior art half bridge generator circuit where the power is controlled by varying the +VDC power supply to the bridge.

FIG. 3 shows a schematic diagram of a prior art full bridge generator circuit where the power is controlled by varying the duty cycle of the gate drive waveforms to the gates of the switching devices in the bridge.

### DESCRIPTION OF THE PREFERRED EMBODIMENTS

At the outset, it should be clearly understood that like reference numerals are intended to identify the same parts, elements or portions consistently throughout the several drawing figures, as such parts, elements or portions may be further described or explained by the entire written specification, of which this detailed description is an integral part. The following description of the preferred embodiments of the present invention are exemplary in nature and are not intended to restrict the scope of the present invention, the manner in which the various aspects of the invention may be implemented, or their applications or uses.

In a preferred embodiment of the invention, the regulator circuit when used with a half bridge circuit is configured as follows: An electronic half bridge circuit with power regulation circuit referenced to system ground and driven by a variable duty cycle waveform comprising an electronic half bridge circuit with DC power supply terminals designated as +VDC and −VDC; a regulator circuit with a first terminal, a second terminal, a source terminal, and a gate terminal, the first terminal is coupled to the −VDC terminal of the electronic half bridge circuit, the second terminal is coupled to the +VDC terminal of the electronic half bridge circuit, the source terminal is coupled to the system ground, and the gate terminal is coupled to a variable duty cycle waveform or waveform generator. The regulator circuit in the preferred embodiment has (a) an inductive element with a first terminal and a second terminal, the first terminal of the inductive element coupled to the −VDC terminal of the half bridge circuit; (b) a switching device with a drain terminal, a source terminal and a gate terminal, the drain terminal of the switching device coupled to the second terminal of the inductive element, the source terminal of the switching device coupled to the system ground of the regulator circuit, and the gate terminal of the switching device coupled to the variable duty cycle drive waveform; (c) a diode with an anode terminal and a cathode terminal, the anode terminal coupled to the second terminal of the inductive element and the cathode terminal coupled to the +VDC terminal of the electronic half bridge circuit; and (d) a capacitive element with a first terminal and a second terminal, the first terminal of the capacitive element coupled to the −VDC terminal of the electronic half bridge circuit, and the second terminal of the capacitive element coupled to +VDC or system ground or both. In the preferred embodiment, the value of voltage at the −VDC terminal of the electronic half bridge circuit changes when the duty cycle of the variable duty cycle waveform changes.

The regulator circuit when used with a full bridge circuit is configured similarly to the configuration used with a half bridge circuit as is readily understood by a person skilled in the art.

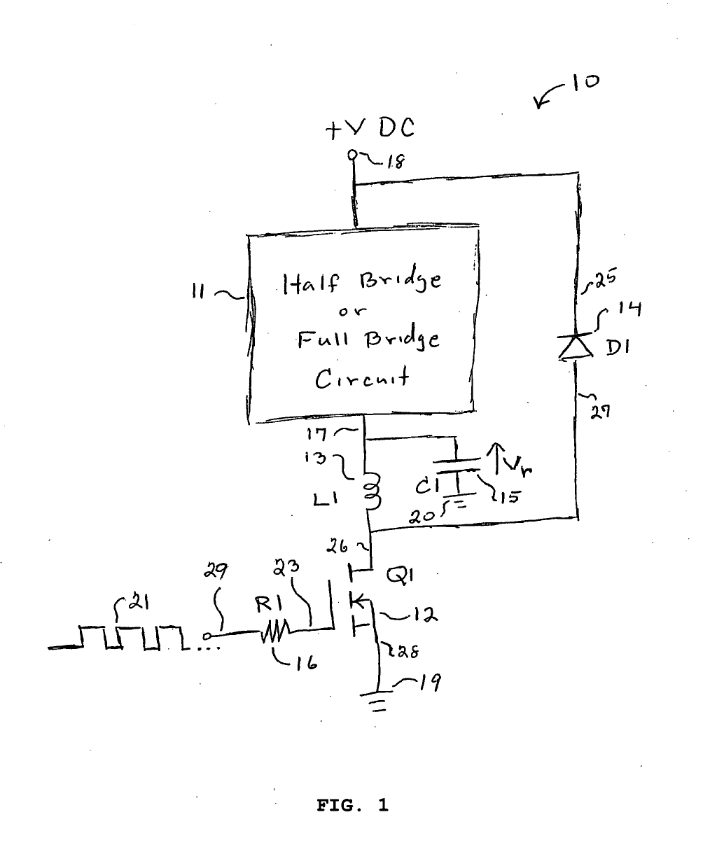

Referring now to the drawings, and first, particularly, to FIG. 1 thereof, a preferred embodiment of the power regulation circuit 10 is illustrated which comprises an electronic half bridge circuit 11 in block diagram form, with a schematic of a power regulation circuit consisting of components 12, 13, 14, 15 and 16 referenced to system ground 19 and driven by a variable duty cycle waveform 21. This circuit 10 comprises an electronic half bridge circuit 11 with DC power supply terminals designated as +VDC 18 and −VDC 17. The circuit 10 of this embodiment further comprises a regulator circuit with a first terminal 17, a second terminal 18, a source terminal 28, and a gate terminal 23. In this embodiment, the first terminal is coupled to the −VDC terminal 17 of the electronic half bridge circuit 11; the second terminal is coupled to the +VDC terminal 18 of the electronic half bridge circuit; the source terminal is coupled to the system ground 19, and the gate terminal 23 is coupled to the variable duty cycle waveform 21. The regulator circuit comprises an inductive element 13 having a first terminal and a second terminal, the first terminal of the inductive element 13 coupled to the −VDC terminal 17 of the half bridge circuit and the second terminal of the inductive element coupled to the drain terminal 26 of a switching device 12. The regulator circuit of this embodiment further comprises a switching device 12 having a drain terminal 26, a source terminal 28 and a gate terminal 23, wherein the source terminal 28 is coupled to the system ground 19, and the gate terminal 23 is coupled to a drive terminal 29 which is coupled to a variable duty cycle drive waveform 21. The regulator circuit further comprises a diode 14 with an anode terminal 27 and a cathode terminal 25, the anode terminal of the diode coupled to the second terminal of the inductive element 26 and the cathode terminal of the diode coupled to the +VDC terminal 18 of the electronic half bridge circuit. This embodiment further comprises a capacitive element 15 with a first terminal and a second terminal, the first terminal of the capacitive element coupled to the −VDC terminal 17 of the electronic half bridge circuit, and the second terminal of the capacitive element coupled to +VDC 18 or system ground 20 or both (the coupling to +VDC is not shown, the coupling to ground 20 is shown; note that capacitor ground 20 and the system ground 19 are electrically equivalent). In this embodiment, the value of voltage at the −VDC terminal 17 of the electronic half bridge circuit 11 changes when the duty cycle of the variable duty cycle waveform 21 changes. A resistor 16 may be added between the drive terminal 29 and the gate terminal 23 to prevent unwanted oscillations. In one embodiment, the first regulator terminal is directly connected to the −VDC power supply line making them the same electrical node.

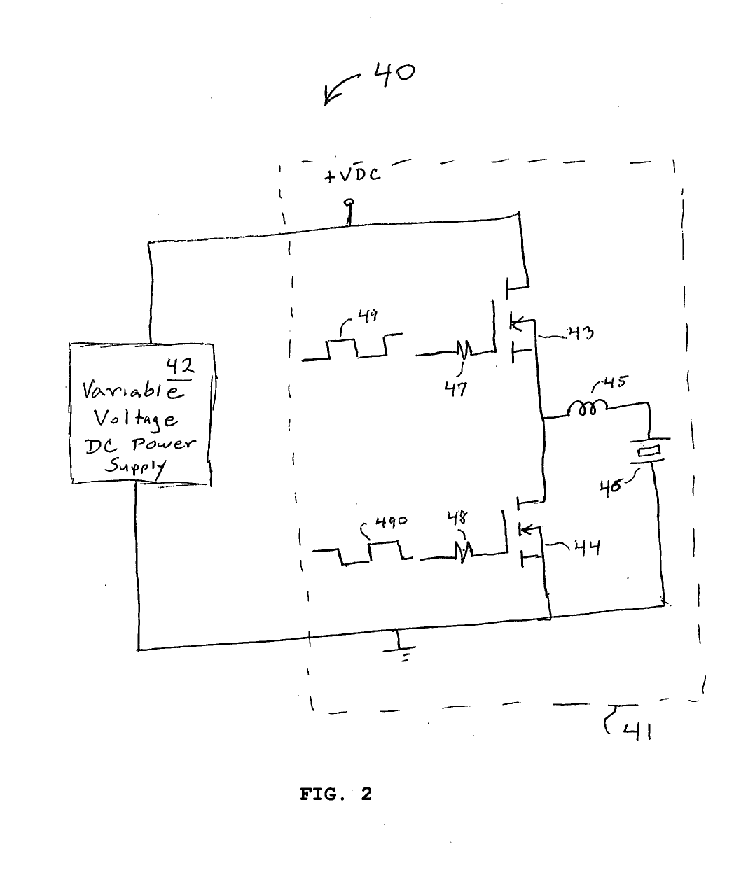

FIG. 2 is included to give a more complete understanding of a preferred embodiment of the invention and to show one of the prior art techniques (circuit 40) for regulating power, i.e., use of a variable voltage DC power supply 42 for a half bridge circuit 41 shown in the dotted box. In this illustration, as variable voltage DC power supply 42 is changed, the output power of the half bridge circuit changes in the same direction. Note that the block diagram 11 in FIG. 1 may comprise the half bridge circuit 41 in FIG. 2.

Half bridge 41 of FIG. 2 operates as follows: when a gate drive signal 49 turns on device 43 through resistor 47, current flows from the DC power supply 42 through device 43 and into inductor 45, continuing into load 46 and back to DC power supply 42. In this example, load 46 is capacitive in nature and therefore increases in voltage as the current charges it. When gate drive signal 490 turns on device 44 through resistor 48, current flows from the charged load 46 through inductor 45, through device 44 and back into load 46. The cycle repeats when gate drive signal 49 turns on device 43 during the next cycle. Note that in this example the gate drive signals 49 and 490 are inverted versions of each other keeping one device off while the other device is on.

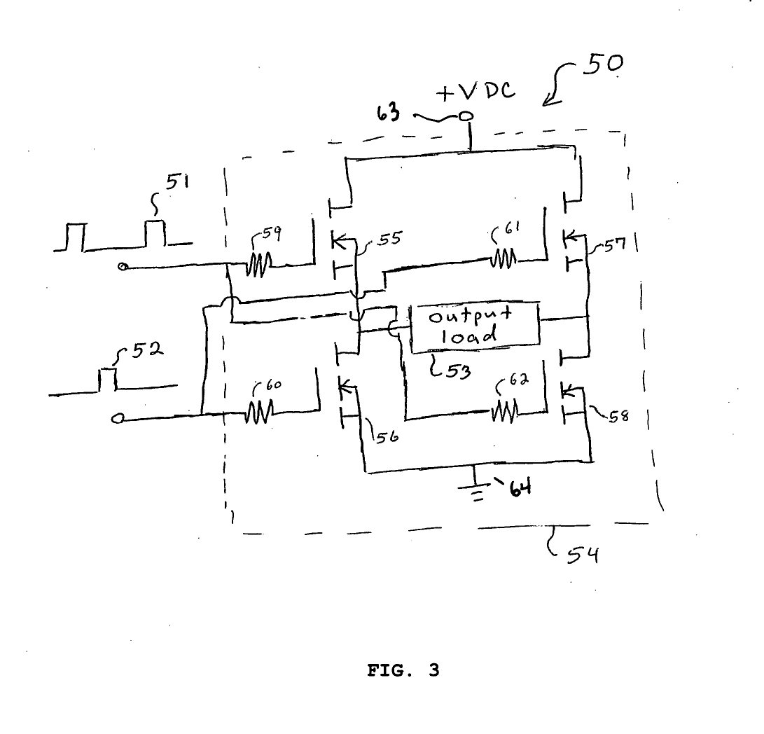

FIG. 3 is included to give a more complete understanding of a preferred embodiment of the invention and to show one of the prior art techniques (circuit 50) for regulating power, i.e., use of variable gate drive duty cycles 51 and 52 for a full bridge circuit 54 shown in the dotted box. In this illustration, as variable gate drive duty cycles 51 and 52 are changed, the output power of the half bridge circuit changes in the same direction. Note that the block diagram 11 in FIG. 1 may comprise the full bridge circuit 54.

Full bridge 54 of FIG. 3 operates as follows: when gate drive signal 51 turns on devices 55 and 58 through resistors 59 and 62, respectively, current flows from the +VDC power supply terminal 63 through device 55 and into output load 53, continuing into device 58 and then into ground 64. When gate drive signal 52 turns on devices 56 and 57 through resistors 60 and 61, respectively, current flows from the +VDC power supply terminal 63 through device 57 and into output load 53, continuing into device 56 and then into ground. The current flowed in the opposite direction through output load 53 during this second half cycle. The cycle repeats when gate drive signal 51 turns on devices 55 and 58 during the next cycle. Note that the gate drive signals 51 and 52 are variable pulse width signals with duty cycles less than fifty percent and ninety degrees out of phase of each other keeping one set of devices off, e.g., 56 and 57, while the other devices are on, 55 and 58. Power delivered to the output load 53 in this example, is decreased by reducing the duty cycle to both gate drive signals 51 and 52, or increased by increasing the duty cycle of both gate drive signals 51 and 52.

During operation of the preferred embodiment described herein, when the switching device 12 is on, charge from the capacitance 15 flows into the inductance 13 and is stored there as energy in the magnetic field; then, when the switching device is off, this energy in the inductor 13 flows through the diode 14 back to the +VDC power supply 18. According to one aspect of the invention, the higher the duty cycle of the switching device, the longer it is on, and therefore more energy is transferred from the node at the bottom of the bridge to the +VDC power supply. This lowers the voltage at the node at the bottom of the bridge which results in a higher voltage drop across the bridge and higher power produced by the bridge circuit. Lower duty cycles to the switching device transfer less energy and the voltage at the node at the bottom of the bridge builds up to a higher value resulting in less voltage drop across the bridge and therefore less power generated by the bridge. In the two extreme cases, that is, the switching device constantly off or fully on, the output power of the bridge circuit is zero power or full power, respectively. The switching device constantly off case can be understood by observing that the voltage of the capacitance at the node at the bottom of the bridge builds up to +VDC and therefore there is no voltage across the bridge. This is a zero power condition. The switching device fully on case can be understood by observing that the voltage of the capacitance at the node at the bottom of the bridge decays down to ground level because the inductor and the on switching device look like a short circuit to ground for this steady state condition. Therefore, there is maximum voltage across the bridge, that is +VDC. This is the maximum power condition.

To simplify the understanding and description of the regulator circuit, system ground was chosen and defined to be at the source terminal of the switching device. It is well known to those skilled in the art that any DC reference point in the circuit can be chosen as the system ground without changing the functionality of the circuit.

The bridge and regulator circuit of this embodiment were described using circuitry and devices where current flows from +VDC at the top of the bridge, through the bridge, through the regulator circuit and into ground or −V. This configuration generally requires switching devices such a N channel power MOSFETs, IGBTs or NPN bipolar transistors. It is readily understood by someone skilled in the art that equivalent operation can be realized with different direction current flow and/or different polarity voltage supplies by using P channel power MOSFETs or PNP bipolar transistors. Also many other switching devices, for example, GTOs (gate turn off thyristors) can be used in these circuits; however, currently the best choices are MOSFETs or IGBTs.

In another embodiment, the capacitive element of the inventive system is obtained from the power supply capacitors of the bridge circuit (half bridge or full bridge) rather than a separate capacitive element in the regulator circuit. For such embodiment, the following description applies: an electronic bridge circuit with first and second power supply lines connected to a power regulation circuit driven by a variable duty cycle waveform comprising: a series connected inductive element and a switching device connected in series with one power supply line of the bridge circuit, a diode element connected from the junction between the inductive element and the switching device to the second power supply line of the bridge circuit, wherein the value of voltage across the power supply lines of the electronic bridge circuit changes when the duty cycle of the variable duty cycle waveform changes. This embodiment may include a capacitive element connected between the first and second power supply lines, or a capacitive element connected between the first power supply line and system ground.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. A circuit for power regulation referenced to system ground and driven by a variable duty cycle waveform, comprising:
a bridge circuit having a positive DC power supply terminal and a negative DC power supply terminal;
a regulator circuit comprising a first terminal, a second terminal, a source terminal, and a drive terminal, wherein said first terminal is coupled to said negative DC power supply terminal, said second terminal is coupled to said positive DC power supply terminal, said source terminal is coupled to said system ground, and said drive terminal is coupled to said variable duty cycle waveform;
said regulator circuit further comprising:
an inductive element having a first inductor terminal and a second inductor terminal, said first inductor terminal coupled to said negative DC power supply terminal;
a switching device having a drain terminal, a gate terminal and said source terminal, said drain terminal coupled to said second inductor terminal, and said gate terminal coupled to said drive terminal;
a diode having an anode terminal and a cathode terminal, said anode terminal coupled to said second inductor terminal and said cathode terminal coupled to said positive DC terminal; and
a capacitive element comprising a first capacitance terminal and a second capacitance terminal, said first capacitance terminal coupled to said negative DC power supply terminal and said second capacitance terminal coupled to said positive DC power supply terminal or said system ground;
wherein the voltage at said negative DC power supply terminal changes as a function of the duty cycle of said variable duty cycle waveform.

2. The circuit of claim 1 wherein said bridge circuit is a half bridge circuit or a full bridge circuit.

3. The circuit of claim 1 wherein said system ground is a DC reference voltage.

4. The circuit of claim 1 wherein said capacitive element is realized from the capacitance associated with said bridge circuit.

5. The circuit of claim 1, further comprising:
means for impressing a source of potential between said positive DC power supply terminal and said negative DC power supply terminal.

6. The circuit of claim 1, further comprising:
a resistor coupled between said gate terminal and said drive terminal.

7. The circuit of claim 1, further comprising:
a variable duty cycle waveform generator coupled to said gate terminal.

8. A bridge circuit with power supply lines for connection to a power regulation circuit driven by a variable duty cycle waveform, comprising:
a switching device connected in series to an inductive element connected in series to a first power supply line; and
a diode element connected between a second power supply line and a junction between said inductive element and said switching device;
wherein said variable duty cycle waveform drives said switching device;
wherein the voltage drop across said first and second power supply lines is a function of the duty cycle of said variable duty cycle waveform.

9. The bridge circuit of claim 8 wherein said bridge circuit is a half bridge circuit or a full bridge circuit.

10. The bridge circuit of claim 9, further comprising:
a capacitive element connected between said first power supply line and said second power supply line.

11. The bridge circuit of claim 9 referenced to system ground, further comprising:
a capacitive element connected between said first power supply line and said system ground.

12. A circuit for power regulation referenced to system ground and driven by a variable duty cycle waveform, comprising:
a bridge circuit having a positive DC power supply terminal and a negative DC power supply terminal;
a regulator circuit comprising a first regulator terminal, a second regulator terminal, a source terminal, and a drive terminal, wherein said first regulator terminal is coupled to said negative DC power supply terminal, said second regulator terminal is coupled to said positive DC power supply terminal, said source terminal is coupled to said system ground, and said drive terminal is coupled to said variable duty cycle waveform;
said regulator circuit further comprising:
an inductive element having a first inductor terminal and a second inductor terminal, said first inductor terminal coupled to said first regulator terminal;
a switching device having a drain terminal, a gate terminal and said source terminal, said drain terminal coupled to said second inductor terminal, and said gate terminal coupled to said drive terminal;
a diode having an anode terminal and a cathode terminal, said anode terminal coupled to said second inductor terminal and said cathode terminal coupled to said second regulator terminal; and
a capacitive element comprising a first capacitance terminal and a second capacitance terminal, said first capacitance terminal coupled to said negative DC power supply terminal and said second capacitance terminal coupled to said positive DC power supply terminal or said system ground;
wherein the voltage at said negative DC power supply terminal changes as a function of the duty cycle of said variable duty cycle waveform.

13. The circuit of claim 12 wherein said bridge circuit is a half bridge circuit or a full bridge circuit.

14. The circuit of claim 12 wherein said system ground is a DC reference voltage.

15. The circuit of claim 12 wherein said capacitive element is realized from the capacitance associated with said bridge circuit.

16. The circuit of claim 12, further comprising:
means for impressing a source of potential between said positive DC power supply terminal and said negative DC power supply terminal.

17. The circuit of claim 12, further comprising:
a resistor coupled between said gate terminal and said drive terminal.

18. The circuit of claim 12, further comprising:
a variable duty cycle waveform generator coupled to said gate terminal.
